(19) United States
(12) Patent Application Publication
(10) Pub. No.: US 2026/0031420 A1
(43) Pub. Date: Jan. 29, 2026

(54) Method for Producing Cathode Material from Spent Batteries

(71) Applicant: H. C. STARCK TUNGSTEN GMBH, Goslar (DE)

(72) Inventors: Juliane MEESE-MARKTSCHEFFEL, Goslar (DE); Armin OLBRICH, Seesen (DE); Alexander EGEBERG, Wiesloch (DE); Alexander ZEUGNER, Wolfenüttel (DE); Alexander WOLFF, Holle (DE); Werner BÄCKER, Wipperfurth (DE)

(21) Appl. No.: 18/998,334

(22) PCT Filed: Aug. 24, 2023
(86) PCT No.: PCT/EP2023/073283

§ 371 Date: Jan. 24, 2025

(30) Foreign Application Priority Data
Aug. 26, 2022 (EP) 22192367.5

(51) Int. Cl. H01M 10/54; C22B 7/00; C22B 26/12; C25B 1/14; H01M 4/02; H01M 4/505; H01M 4/525

(52) U.S. Cl. CPC H01M 10/54; C22B 7/007; C22B 26/12; C25B 1/14; H01M 4/505; H01M 4/525; H01M 2004/028

(57) ABSTRACT

The present invention relates to a method for producing cathode material from spent batteries, and to cathode material obtained according to the method of the invention.

The present invention relates to a process for producing cathode material from spent batteries, and to a cathode material obtained by the process according to the invention.

The traffic or mobility transition designates the social, technological and political process in which the traffic and mobility are converted to sustainable energy sources, a mild usage of mobility, and the networking of different forms of individual traffic and local public transportation. One pillar of the mobility transition is the so-called drive transition, which involves the gradual replacement of internal combustion engines by those driven by hydrogen, fuel cells, or by battery electric power.

The declared and most important goal of the mobility transition is climate and environmental protection. In order to achieve this, not only is it essential to reduce CO2 emissions, but also an efficient closed-circuit system to avoid pollution of the environment and the threat of raw material shortages in the production of battery-electric drive alternatives.

In the field of battery-electric drives, lithium-ion batteries (LIB) in particular have proven to be a promising storage system for the required electrical energy. However, without a parallel and sensible global recycling strategy for such batteries, the declared goal of the mobility transition cannot be achieved. A holistic recovery of the valuable metals contained in used battery materials, such as cobalt, nickel and manganese, but especially lithium, is therefore essential. The primary production of lithium from brines uses the power of the sun, which initially seems ecologically compatible, but the current production is associated with major interventions in the water balance of the relevant regions. According to studies, a specific fresh water consumption of around 44 liters per kilogram of lithium extracted can be expected. Even if the global lithium reserves are estimated to be relatively high, they are finite and the primary production process described is lengthy. Quantitative and rapid recovery through sustainable recycling of lithium together with the other valuable metals cobalt, nickel and manganese for the production of new cathode active materials (CAM) is in any case preferable. The first efforts at a sustainable recycling cycle are described in the prior art.

Thus, US 2013/0302226 describes a method of recycling batteries comprising: producing a solution of battery materials from used cells; precipitating impurities from the solution produced; adjusting the solution to achieve a predefined ratio of desired materials; and precipitating the desired material at said predefined ratio, to form cathode material for a new battery having said predefined ratio of desired transition metals.

US 2017/0077564 relates to a process for recycling lithium-ion batteries, comprising: identifying a molar ratio for cathode materials for a new battery; forming a leaching solution by combining comminuted battery material from a lithium battery recycling stream with an acidic leaching agent and hydrogen peroxide (H₂O₂) to separate cathode materials from undissolved materials; filtering the undissolved materials from the leaching solution formed, so that the dissolved salts of the cathode materials remain in the leaching solution; determining a composition of said leaching solution by identifying a molar ratio of the salts of the cathode material dissolved therein; adding Ni, Co, Mn or Al salts as sulfates (xSO₄) of hydroxides (xOH) based on the determined composition, in order to adjust the molar ratio of the dissolved cathode material salts in the leaching solution to correspond to the identified molar ratio for the recycled battery, including the addition of a solution of aluminum sulfates and a chelating agent; and increasing the pH of the leaching solution to at least 10 to precipitate and filter off metal ions of the cathode materials to form a charge material precursor by converting the Ni, Co, Mn and Al salts remaining in the lye solution as a combined hydroxide (OH)₂ or carbonate (CO₃) at a molar ratio equal to the identified molar ratio for the recycled battery, wherein the charge precursor material responds to sintering to form active cathode materials in an oxide form after sintering with lithium carbonate (Li₂CO₃). It should be emphasized that all pH adjustments and in particular the precipitation of the precursor are carried out by adding NaOH.

The methods proposed in the prior art attempt to avoid the separation and energy-consuming conversion of the transition metals into their solid sulfates as much as possible and to use the resulting mixed solution with Ni/Co/Mn sulfate and Li₂SO₄ directly for the precipitation of the cathode precursor after adjusting the transition metal stoichiometry. However, in conventional processes, lithium is recovered as poorly soluble Li₂CO₃ by adding Na₂CO₃. However, due to the solubility ratios of lithium carbonate and lithium sulfate, this approach is complex and makes actual quantitative recovery of lithium virtually impossible or only possible at considerable cost. A non-quantitative recovery of lithium not only has cost disadvantages, but the release of solutions containing lithium salt into nature (inland waters) is generally not possible for environmental reasons.

Furthermore, the recovery of lithium as carbonate represents a resalting process, which is associated with a further generation of neutral salt in addition to the neutral salt load that arises from the precipitation of the precursor. Thus, all in all, it is to be considered that at least 1.5 moles of Na₂SO₄ are formed per mole of LiMO₂. There is therefore still a need for a process that allows the efficient and quantitative recovery of cathode materials from lithium-ion batteries that are no longer used.

This need is addressed by the present invention, which has surprisingly found that the production of cathode materials from battery waste can be based entirely on lithium hydroxide (LiOH) instead of sodium hydroxide (NaOH), which, on the one hand, avoids the neutral salt waste that usually occurs and low-sodium or sodium-free products can be produced without increasing the actual need for LiOH.

Therefore, the present invention firstly relates to a process for producing cathode material from spent batteries, comprising the steps of:
a) dissolving the cathode material from shredded battery waste by treating it with a leaching agent to obtain a cathode material precursor solution;
b) treating the cathode material precursor solution with LiOH to obtain a solid cathode material precursor mixed hydroxide and a filtrate containing at least the Li salt of the leaching agent;
c) separating the filtrate obtained in step b), and splitting the filtrate into LiOH and leaching agent using electrolysis;
d) converting the cathode material precursor mixed hydroxide to active cathode material making at least partial use of the LiOH recovered in step c).

Within the scope of the present invention, it has been surprisingly found that by using LiOH, the use of which is usually not preferred due to its high cost, not only could the amount of neutral salt waste be reduced, but an improvement in the CO₂ footprint could also be achieved.

Within the scope of the process according to the invention, the transition metals contained in the cathode material of used lithium-ion batteries, in particular Ni, Co and Mn, are converted into the soluble form of their salts in a cathode material precursor solution by treatment with a leaching agent. The transition metals are then precipitated from this solution, optionally after pre-cleaning and/or partial separation, by adding LiOH in the form of a solid mixed hydroxide, which forms the precursor for the later active cathode material. The lithium salt of the leaching agent is obtained as a filtrate, which is converted back into LiOH and the leaching agent by means of electrolysis. The mixed hydroxide of the transition metals obtained in the process according to the invention is further converted into the active cathode material, which can then be used to produce lithium-ion batteries, thereby closing the recycling loop.

As part of the process according to the invention, used lithium-ion batteries in particular are used as battery waste and in particular their cathode material. The cathode material is in particular selected from the group consisting of LiMO₂ layer structures with preferably M=Ni, Co and/or Mn and/or Al, in particular LiCo oxides (LCO), Li(Ni/Co) oxides (LNCO), Li(Ni/Co/Mn) oxides (LNCMO), Li(Ni/Co/AI) oxides (LNCAO), Li(Ni/AI) oxides (LNAO), Li(Ni/Mn) oxides (LNMO) or LiM₂O₄ spinel structures with preferably M=Ni, Co and/or Mn, optionally with Al doping or any mixtures.

In a preferred embodiment, the cathode material employed contains Ni and Co and preferably Mn and/or Al.

Before use in the process according to the invention, the cathode material can be subjected to a cleaning step in order to remove organic solvents and electrolyte residues such as LiPF₆. Therefore, in a preferred embodiment, the process according to the invention comprises a step of cleaning the cathode material to be employed. Preferably, this cleaning step consists of washing the cathode material with water.

In a preferred embodiment, the leaching agent is a mineral acid, preferably sulfuric acid. In a further preferred embodiment, a reducing agent is added to the leaching agent, the reducing agent preferably being H₂O₂ or SO₂.

The cathode material obtained from the battery waste may contain other components such as iron, copper or aluminum, which are also converted into the form of their soluble salts by treating the cathode material with the leaching agent and are accordingly found in the cathode material precursor solution. In these cases it is advantageous to carry out pre-cleaning. Therefore, an embodiment is preferred in which the process according to the invention further comprises a pH-dependent precipitation of at least one of the salts of Fe, Cu and Al from the cathode material precursor solution. In contrast to the common procedure of precipitating the metals by adding NaOH, the precipitation in the process according to the invention is preferably carried out by adding LiOH. Alternatively, the impurities can also be separated off by solvent extraction. In this case, any activation of the extractant used or pH adjustment is also preferably carried out with LiOH. Regardless of the pre-cleaning method chosen, the entry of sodium into the process cycle is avoided.

The cathode material precursor mixed hydroxide NiₓCo_{y}Mn_{z}(OH)₂ is precipitated from the cathode material precursor solution, optionally after removal of Fe, Cu and/or Al, which serves as the basis for the production of the active cathode material. This procedure has the advantage that there is no need for a complex complete separation and separate crystallization of the individual transition metal salts. Contrary to what is described in some prior art processes, in the process according to the invention the lithium is not precipitated together with the transition metal salts, but rather remains in solution.

The transition metals are present in the active cathode materials (CAM) in a certain ratio to one another, which, among other things, determines the performance of the battery. This ratio of transition metals is usually achieved through an appropriate adjustment in the precursor of the cathode material.

Therefore, an embodiment is preferred in which the process according to the invention further comprises a step of controlling and optionally adjusting, preferably of the cathode material precursor solution, with respect to the metal stoichiometry depending on the desired composition of the active cathode material to be produced.

The metal stoichiometry is conventionally adjusted by adding the corresponding component or components, which has the disadvantage that sometimes significant amounts of “new” material, usually in the form of solid sulfates, have to be applied, as described, for example, in US 2017/0077564. During the crystallization of the sulfates, considerable amounts of energy are consumed by evaporating water, which in the case of nickel results in a CO₂ footprint of around 1.5 kilograms of CO₂ per kilogram of Ni. However, to protect the climate, any unnecessary production of CO₂ should be avoided.

In the context of the present invention, it was surprisingly found that the adjustment can be carried out by targeted separation, thereby avoiding the use of additional material and the associated disadvantages. Therefore, an embodiment is preferred in which the adjustment is carried out by at least partially separating off one or more of the components of the cathode material precursor solution, preferably by solvent extraction. In this case, any activation of the extractant used or pH adjustment is preferably carried out with LiOH. This procedure is particularly advantageous insofar as the current cathode material, in which Ni, Co and Mn are present in a ratio of 1:1:1, is currently being converted to nickel-rich materials in which the transition metals are present, for example, in a ratio of Ni:Co:Mn of 8:1:1 is present, a ratio which would otherwise require the addition of large amounts of nickel to achieve.

The process according to the invention provides that a solid cathode material precursor mixed hydroxide and a filtrate containing at least the Li salt of the leaching agent are obtained from the cathode material precursor solution by treatment with LiOH. In a preferred embodiment, the treatment is carried out in such a way that the precipitation of the cathode material precursor is carried out at a pH of 9 to 14, preferably 10 to 13. The pH value information refers to the operating temperature. In order to carry out the precipitation in a controlled manner and to obtain spherical particles, NH₃ can be added during the precipitation process, the NH₃ concentration preferably being 1-17 g/I, preferably 5-15 g/l, particularly preferably 8-12 g/I amounts. The precipitation can be carried out at room temperature, but preferably between a temperature of 20 and 80° C., particularly preferably between 4° and 65° C.

In step c) of the process according to the invention, the filtrate obtained in step b) is split into LiOH and corresponding leaching agent by means of electrolysis, whereby the leaching agent used in step a) can be recovered. In a preferred embodiment, electrodialysis technology is used for electrolysis. In a particularly preferred embodiment, bipolar membranes are additionally used for the electrolysis, which means that a significant increase in the space/time yield can be achieved.

As stated above, the filtrate obtained in step b) of the process according to the invention may contain NH₃. Therefore, for purification, the filtrate can be subjected to distillation before electrolysis.

The process according to the invention aims to provide a closed circuit. Therefore, an embodiment is preferred in which the leaching agent obtained in step c) is at least partially used for the treatment of the cathode material in step a) of the process according to the invention.

In a particularly preferred embodiment, the LiOH obtained in step c) of the process according to the invention is at least partially used to treat the cathode material precursor solution in step b).

In a preferred embodiment, the LiOH obtained in step c) of the process according to the invention is at least partially converted into a solid state, preferably in the form of solid LiOH*H₂O and/or Li₂CO₃. This can be used advantageously in the further course of the process. The conversion to Li₂CO₃ is advantageously carried out by treating the LiOH with CO₂.

Step d) of the process according to the invention provides for the conversion of the obtained cathode material precursor mixed hydroxide to the active cathode material making at least partial use of the LiOH recovered in step c). In a preferred embodiment, the reaction takes place by reacting with solid LiOH*H₂O or Li₂CO₃.

In a preferred embodiment, the LiOH converted into its solid state from step c) of the process according to the invention is at least partially used for the conversion of the cathode material precursor mixed hydroxide to the active cathode material, whereby a further gap in the circuit is closed.

In contrast to conventional prior art processes, the process according to the invention relies on LiOH. Therefore, an embodiment is preferred in which no NaOH is used in the process. On the one hand, this avoids the neutral salt waste that would otherwise arise and, on the other hand, the electrical energy required to recover LiOH through electrolysis is slightly lower compared to the production of NaOH through conventional chloralkali electrolysis, which in turn has a positive effect on the CO₂ footprint. The energetic advantage of the overall process is even higher if, when using NaOH, the neutral salt Na₂SO₄ obtained has to be crystallized out by water evaporation because, depending on the location, it cannot be released directly into the environment. The present process not only does not have this energy disadvantage, but is also completely flexible with regard to the location issue. Furthermore, the amounts of LiOH produced are used again to produce the cathode precursor material, so that only very small amounts of LiOH actually need to be present in the recycling company's cycle.

The process according to the invention makes it possible for the only source of Na input to be the cathode material to be recycled. The amounts of Na introduced can be removed from the circulation process, for example via solvent extraction or ion exchanger or also using electrochemical processes. Depending on needs, this can be done continuously or at more or less long intervals. In this context, the process according to the invention allows the Na to disappear from the global battery circuit over time.

A further aspect of the present invention is a cathode material, in particular for lithium-ion batteries, obtained by the process according to the invention, wherein the cathode material is essentially free of sodium, wherein the sodium content is preferably less than 500 ppm, preferably less than 50 ppm, more preferably less than 10 ppm, respectively based on the total weight of the cathode material. The cathode material preferably has a stoichiometry of the transition metals of Ni_{8/10}Co_{1/10}Mn_{1/10} or Ni_{1/3}Co_{1/3}Mn_{1/3}.

The advantages of the present invention shall be illustrated by means of the following Examples and Figures, which should not be understood as limiting the idea of the invention, however.

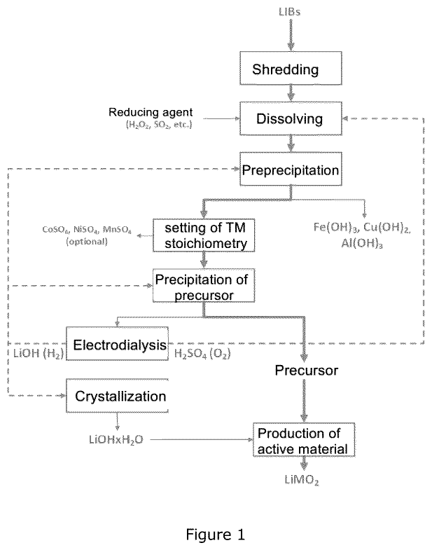

FIG. 1 schematically shows a preferred course of the process according to the invention. The used lithium-ion batteries (LIB) are first crushed and then mixed with a leaching agent and, if necessary, with a reducing agent in order to bring the valuable metals contained in the cathode material of the used LIBs into solution (cathode material precursor solution). Undesirable components such as Fe, Cu or Al can be separated from this solution in the form of their hydroxides by adding LiOH and adjusting the appropriate pH value. The separated hydroxides can then be fed into an adjacent recycling cycle. In the purified solution, the ratio of Ni, Co and Mn to one another is controlled and, if necessary, adjusted depending on the desired stoichiometry in the later active cathode material. The metals Ni, Co and Mn are then precipitated by adding LiOH as a precursor (cathode material precursor mixed hydroxide) and are further converted into the desired active cathode material. The filtrate (mother liquor) obtained during the precipitation is separated back into LiOH and leaching agent, for example sulfuric acid, using electrodialysis. The leaching agent is fed back into the process and the LiOH is partially converted into solid LiOH*H₂O and partially fed back into the process cycle. The solid LiOH*H₂O can be used, for example, to produce the active cathode material from the cathode material precursor mixed hydroxide, thereby completing the cycle.

The present invention offers the advantage that it allows the common Ni_{1/3}Co_{1/3}Mn_{1/3} cathode material to be efficiently converted to the Ni-richer material Ni_{8/10}Co_{1/10}Mn_{1/10}. Tables 1 and 2 compare the inventive solution of adjustment by separation and the addition method common in the prior art. Table 1 illustrates the amounts of Ni, Co and Mn that arise as feedstock for 1000 kg of common Ni_{1/3}Co_{1/3}Mn_{1/3}(“mix of thirds”) and the amounts of Co and Mn that need to be separated off to achieve the new Ni-rich stoichiometry. The “excess” Co obtained in this way can, for example, be processed into Co metal powder, and “excess” Mn can be passed on directly to the steel industry as Mn hydroxide or Mn oxyhydroxide.

TABLE 1

| | | | | |
|---|---|---|---|---|
| Mix of thirds | Metal | Ni | Co | Mn |
| | Stoichiometry | ⅓ | ⅓ | ⅓ |
| | kmol | 3.46 | 3.46 | 3.46 |
| | kg | 202.82 | 203.65 | 189.84 |
| Separation | | 0.00 | 178.19 | 166.11 |
| High Ni active | kg | 202.82 | 25.46 | 23.73 |
| material | kmol | 3.46 | 0.43 | 0.43 |
| | Stoichiometry | 8/10 | 1/10 | 1/10 |
| | Metal | Ni | Co | Mn |

Alternatively, NiSO₄ can be added to adjust the desired stoichiometry as described in the prior art. This results in the scenario shown in Table 2 with an obviously high proportion of purchased goods.

TABLE 2

| | | | | |
|---|---|---|---|---|
| Mix of thirds | Metal | Ni | Co | Mn |
| | Stoichiometry | ⅓ | ⅓ | ⅓ |
| | kmol | 3.46 | 3.46 | 3.46 |
| | kg | 202.82 | 203.65 | 189.84 |
| Purchase | | 1419.75 | 0.00 | 0.00 |
| High Ni active | kg | 1622.57 | 203.65 | 189.84 |
| material | kmol | 27.64 | 3.46 | 3.46 |
| | Stoichiometry | 8/10 | 1/10 | 1/10 |
| | Metal | Ni | Co | Mn |

As can be seen from Table 2, the stoichiometry setting is achieved through massive purchases of “virgin material”—in this case the Ni component. According to the upper estimate, the purchase of Ni leaves a CO₂ footprint of around 1.5 kg CO₂ per kg Ni, which is avoided by the procedure according to the invention.

The following explains the advantages achieved by using LiOH instead of NaOH.

### Chloralkali Electrolysis

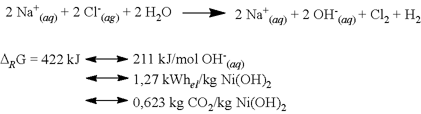

Chloralkali electrolysis currently produces around 60 million tons of NaOH per year worldwide, which is also used in the production of the precursors for active materials in lithium-ion batteries in accordance with the state of the art. This corresponds to a minimum emission of around 18 million tons of CO₂ per year. Li₂SO₄ electrodialysis

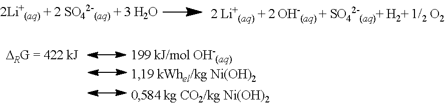

Alternatively, Li₂SO₄ electrodialysis is advantageously provided as part of the process according to the invention. The Gibbs free energies refer to the minimum electrical work that must be done. Due to overvoltages and ohmic resistances, the actual electrical work required, for example for chloralkali electrolysis, is around 50% higher. This means that the use of NaOH as a precipitant has a CO₂ footprint of around 1 kg CO₂ for 1 kg of precursor.

Lithium sulfate electrolysis even requires slightly less energy than chloralkali electrolysis. There is also the possibility of further reducing the energy requirement of the electrochemical process by significantly increasing the efficiency when using lithium sulfate electrodialysis by stacking bipolar membranes.

1. A process for producing cathode material from spent batteries, comprising the steps of:
a) dissolving the cathode material from shredded battery waste by treating it with a leaching agent to obtain a cathode material precursor solution;
b) treating the cathode material precursor solution with LiOH to obtain a solid cathode material precursor mixed hydroxide and a filtrate containing at least the Li salt of the leaching agent;
c) separating the filtrate obtained in step b), and splitting the filtrate into LiOH and leaching agent using electrolysis; and
d) converting the cathode material precursor mixed hydroxide to active cathode material making at least partial use of the LiOH recovered in step c).

2. The process according to claim 1, characterized in that the cathode material contains Ni and Co and Mn and/or Al.

3. The process according to claim 1, characterized in that the cathode material used in step a) is subjected to a cleaning step before treatment with the leaching agent, wherein the cleaning step includes of washing with water.

4. The process according to claim 1, characterized in that the leaching agent is a mineral acid, wherein the leaching agent further comprises a reducing agent.

5. The process according to claim 1, characterized in that the process further comprises a pH-dependent precipitation of the salts of Fe, Cu and/or Al from the cathode material precursor solution, wherein the pH value is adjusted by adding LiOH.

6. The process according to claim 1, characterized in that the process further comprises a step of controlling and optionally adjusting the cathode material precursor solution with respect to the metal stoichiometry depending on the desired composition of the cathode material to be produced.

7. The process according to claim 6, characterized in that the adjustment is carried out by at least partially separating off one or more of the components of the cathode material precursor solution.

8. The process according to claim 1, characterized in that the cathode material precursor solution has a pH of 9 to 14.

9. The process according to claim 1, characterized in that the filtrate is subjected to distillation before electrolysis.

10. The process according to claim 1, characterized in that electrodialysis technology is used for electrolysis.

11. The process according to claim 1, characterized in that the leaching agent recovered in step c) is used at least in part for the treatment in step a).

12. The process according to claim 1, characterized in that the LiOH obtained in step c) is at least partially converted into a solid state.

13. The process according to claim 12, characterized in that at least part of the LiOH converted into its solid state is used to convert the cathode material precursor mixed hydroxide into active cathode material.

14. The process according to claim 1, characterized in that the LiOH used in step b) is at least in part the LiOH recovered in step c).

15. The process according to claim 1, characterized in that no NaOH is used in the process.

16. A cathode material, obtained by the process according to claim 1, characterized in that the cathode material is essentially free of sodium, wherein the content of sodium or one of its compounds is than 500 ppm, based on the total weight of the cathode material.

17. The process according to claim 1, characterized in that the cathode material contains Ni, Co, and Mn.

18. The process according to claim 1, characterized in that the leaching agent is sulfuric acid and the reducing agent comprises H₂O₂ or SO₂.

19. The process according to claim 1, characterized in that the cathode material precursor solution has a pH of 10 to 13.

20. The process according to claim 12, characterized in that the LiOH obtained in step c) is at least partially converted into a form of solid LiOH*H₂O and/or Li₂CO₃.
